(19) United States
(12) Patent Application Publication
(10) Pub. No.: US 2026/0305543 A1
(43) Pub. Date: Oct. 8, 2026

(54) Method and Equipment for Harvesting Mushrooms from a Growing Bed

(71) Applicant: Jacobus Alexander Jozef Lemmen, Venlo (NL)

(72) Inventor: Jacobus Alexander Jozef Lemmen, Venlo (NL)

(21) Appl. No.: 19/481,554

(22) PCT Filed: May 3, 2024
(86) PCT No.: PCT/EP2024/062359

§ 371 Date: Nov. 5, 2025

(30) Foreign Application Priority Data
May 5, 2023 (NL) 2034767

(51) Int. Cl. A01G 18/70

(52) U.S. Cl. CPC A01G 18/70

(57) ABSTRACT

The invention concerns a method and device (1) for harvesting mushrooms (2) from a growing bed (3). The method includes placing an insulation layer (3) on the growing bed, in particular for insulating fungi and germs, placing a carrier layer (15), such as a cloth, on the insulation layer (13) for receiving harvested mushrooms, harvesting the mushrooms using a cutting or sawing device and transferring the mushrooms (2) to the carrier layer (15), removing the mushrooms (2) with the carrier layer (15) and all from the insulation layer (13) while the insulation layer (13) remains on the growing bed (3), and removing the insulation layer (13).

The present invention relates to a method and device for harvesting mushrooms from a growing bed. More particularly, the invention relates to such a method and device, where the harvesting is carried out mechanically.

Harvesting mushrooms is a labour-intensive step in mushroom production, especially when carried out manually. Such manual harvesting has the main advantage that mushrooms can be selectively picked from a growing bed, with the choice then being between mushrooms that can be picked because of their degree of maturity, or mushrooms that need to be picked because they will otherwise hinder the growth of other mushrooms. A second advantage is that the further handling of the harvested mushrooms can be better controlled, which is especially important for mushrooms that will eventually have to be sold in trays. A third advantage of manual harvesting is that there is little or no chance of spreading diseases that may occur on a mushroom bed. This disadvantage occurs particularly when automated cutting or slicing is used, where a cloth is used to catch mushrooms and remove them from the bed. Such a cloth is dragged across the bed when removing the cut mushrooms from the bed, where diseases can be spread. All the reason why ways are being sought to automate this step in such a way that the benefits of manual harvesting are achieved.

It is therefore an object of the present invention to provide a method and device for harvesting mushrooms from a growing bed that at least partially eliminates the aforementioned drawbacks.

To this end, the invention provides a method for harvesting mushrooms from a growing bed, comprising applying an insulating layer to the growing bed (on top of the growing bed), in particular for insulating fungi and pathogens, applying a carrier layer to the insulating layer (on top of the insulating layer), such as a cloth for receiving harvested mushrooms, harvesting the mushrooms using a cutting or sawing device and transferring the mushrooms to the carrier layer, removing the mushrooms together with the carrier layer from the insulation layer while the insulation layer remains on the growing bed and optionally removing the insulation layer. This last step will be necessary before the next flush of mushrooms can be grown on the bed.

The insulation layer ensures that the carrier layer does not come into direct contact with the growing bed. This is especially important when removing the carrier layer, which can now be done by moving it over the insulation layer away from the growing bed, leaving the mushrooms on the carrier layer and leaving the insulation layer on the growing bed. The carrier layer can be removed by rolling it up and gradually dragging it across the cultivation bed. The mushrooms can thereby be removed from the carrier layer while it is still on the growing bed, or transferred at the level of a roll-up device, such as a spool or mandrel.

Preferably, the insulation layer and carrier layer are applied simultaneously. This can be done by applying them to the growing bed from two different dispensing devices, or—as this allows for the most efficient work—from one dispensing device. By further preference, this is done while cutting and/or sawing the mushrooms. In this way, the growing bed is filled as fast as possible and a single device can be used to cut and dispense the mushrooms.

The growing bed and the cutting or sawing device and a dispensing device for the carrier layer and/or insulation layer may be moved between them to harvest the mushrooms and apply the carrier layer and/or insulation layer, where the bed may be moved and the cutting or sawing device and dispensing devices may be stationary, but preferably the cutting or sawing device and a dispensing device for the carrier layer and/or insulation layer are moved along the bed.

The growing bed can thereby extend in a longitudinal and transverse direction, wherein the insulation layer and/or carrier layer can be supplied from a side in the transverse direction, and discharged to a side (or end) in the longitudinal direction. Additionally and/or alternatively, the insulation layer and/or carrier layer can be both supplied from an end in the longitudinal direction, and discharged to the same or an opposite end in the longitudinal direction.

The invention further relates to a device for harvesting mushrooms from a cultivation bed, in particular a cultivation bed provided with compost and possibly casing soil, forming on an upper surface a harvest surface on which mushrooms can be cultivated and subsequently harvested, which harvest surface extends in a longitudinal direction and a transverse direction, the device comprising a knife or assembly of knives having an effective cutting surface or effective cutting line extending across the width of the harvest surface in at least one directional component in the transverse direction, wherein the growing bed and the knife or assembly of knives are mutually movable with at least one directional component in the longitudinal direction of the harvest surface such that the effective cutting plane or effective cutting line can completely cover the harvest surface, and a first dispensing device for applying to the harvest surface an insulating layer for insulating fungi and pathogens, such as a film and a second dispensing device, for applying to the insulation layer a support for harvested mushrooms, such as a cloth or net.

The first and/or second dispensing device may be coupled to the effective cutting plane or effective cutting line of the knife and, together with the knife or assembly of knives, movable with respect to the bed for applying the insulation layer and/or carrier layer at a fixed distance from the effective cutting plane or effective cutting line of the knife and thereby on a harvested part of the harvest surface.

The knife or assembly of knifes according to the invention may comprise, for example, an assembly of rotating knifes as described in Dutch patent application NL2032382 which is incorporated herein by reference, or a single saw making a reciprocating cutting movement. Preferably the cutting or sawing device is formed by a bandsaw, belt saw or gang saw. Such bandsaw, belt saw or gang saw may by further preference extend in the transverse direction over a width that is over dimensioned with respect to the width of the growing bed in said transverse direction, in order to ensure that all mushrooms on the bed can be harvested. The saw band or belt is looped around at least two or more wheels or pulleys for that purpose, which wheels are then necessarily mutually spaced at a distance larger than the width of the beds and the shelving. In order to be able to move the cutting or sawing device relative to the beds, it should be movable in the traverse direction in case the shelving is provided with uprights at its sides in the width direction.

To facilitate the movement of the cutting or sawing device, the shelving may be arranged such that it has no uprights at both sides of the shelving, positioned exaction opposite to each other, but always a bit apart in the length direction. For instance, such uprights may be positioned alternatingly at one side or another of the growing beds, in a zig-zag manner.

An effective cutting plane or line means the plane or line on which the cutting of the mushrooms takes place. Where use is made of an assembly of knives, for example a number of rotating knives, preferably arranged partially overlapping each other, such an effective cutting line is a shape composed of outlines of the different knives. Such a line need not comply with the purely mathematical definition but can have curvatures, or, on the contrary, be a tangent to points on the various knives.

The first and/or second dispensing device may thereby include a dispensing point adjacent to the effective cutting edge or effective cutting line of the knife, for applying the insulation layer and/or carrier layer during use immediately after harvesting. The dispensing point is thereby the point (or line) at which the carrier layer or insulating layer is placed on the growing bed. This point moves relative to the bed during application, as the bed is moved relative to the dispensing device or the dispensing device is moved relative to the bed.

For example, the first and/or second dispensing device may comprise a roll on which the insulating layer and/or carrier layer is applied, wherein the roll is arranged adjacent to the harvest surface in the width direction and guided around a bending line extending with both a directional component in the longitudinal direction and in the transverse direction, and in particular diagonally across the harvest surface, for applying the insulating layer and/or carrier layer in a longitudinal direction of the growing bed during use.

The device may also include a discharge device, for discharging the carrier layer in a longitudinal direction from the growing bed, in particular with the harvested mushrooms. At some location above the carrier layer may thereby include a scanning device, for scanning harvested mushroom on the carrier layer for determining the weight or shape or quality of the harvested mushrooms, and a sorting device for sorting the mushrooms by weight or shape or quality and/or a packaging device for packaging the mushrooms. The discharging device may in a preferred embodiment be configured to dispend the carrier layer at a higher speed than the relative speed of the cutting device and the bed. This results in spreading the harvested mushrooms, which makes further processing thereof easier. In particular when a graphical recognition of the mushrooms forms part of the further processing step, physical separation of the harvested mushrooms is beneficial.

According to the invention, packaging takes place without intermediate storing step. For that goal, a picking device, such as a robot, may be configured for picking mushrooms from the carrier layer based on visual recognition information, and to directly transfer the mushrooms to a packaging. Picking mushrooms by a robot and delivering them to a packaging may be done while measuring the weight of the package while being filled by the robot.

The device according to the invention may further comprise a takeover plane extending between the cutting or sawing device and the carrier layer, thereby guiding the just-harvested mushrooms from the knife or assembly of knives to the carrier layer.

The invention further relates to a shelving comprising multiple beds arranged on either side of a central upright, and freely accessible from a side facing away from the upright, and in particular provided with multiple beds arranged one above the other, wherein at least one of the beds is provided with a knife or assembly of knives having an effective cutting edge or effective cutting line extending across the width of the harvest surface by at least a directional component in the width direction wherein the growing bed and the knife or assembly of knifes are mutually movable with at least one directional component extending longitudinally across the harvest surface such that the effective cutting plane or effective cutting line can completely cover the harvest surface, a first dispensing device for applying to the harvest surface an insulating layer for insulating fungi and pathogens, such as a film and a second releasing device, for applying to the insulation layer a support for harvested mushrooms, such as a cloth or net. Preferably, this involves sharing the knife or assembly of knives and the dispensing devices with several beds.

The invention will now be elucidated with reference to the following figures, wherein:

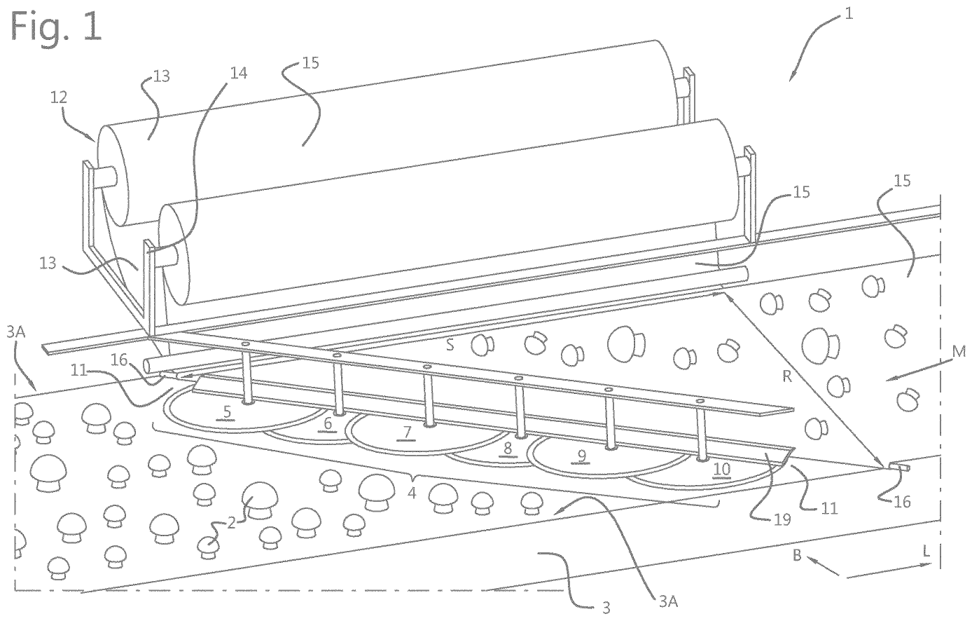

FIG. 1 shows a detail of the present invention, and;

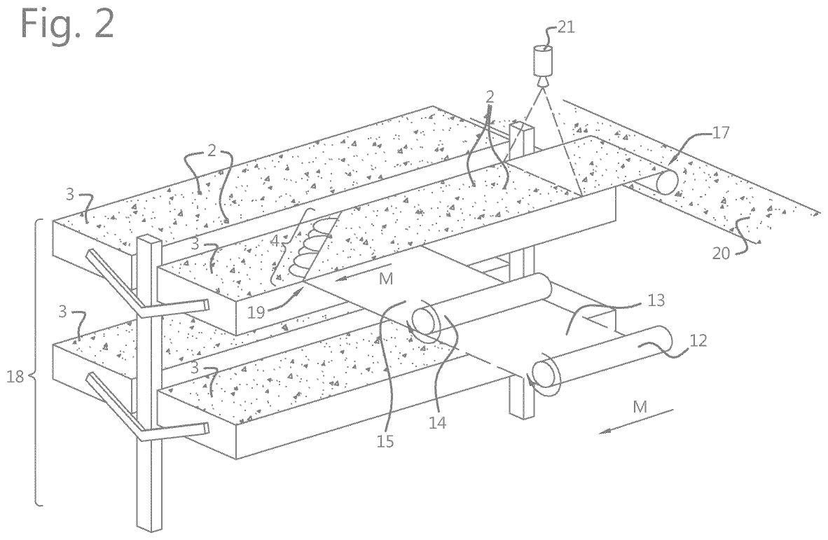

FIG. 2 shows an overview of the present invention.

FIG. 1 shows a device 1 for harvesting mushrooms 2 from a growing bed 3 provided with compost and casing soil 3, having at an upper end a harvest surface 3A on which mushrooms 2 are growable and subsequently harvestable, which harvest surface 3A extends in a longitudinal direction L and a transverse direction B. The device comprises an assembly 4 of knives 5-10 having an effective cutting line 11, extending across the width of the harvest surface with at least a directional component R in the width direction B, and in the example shown also with a directional component S in the longitudinal direction L. Consequently, the effective cutting line extends diagonally across the cultivation bed 3.

The assembly 4 of knifes is movable in the longitudinal direction L (in the representation shown during harvesting in a direction M, in negative direction of the arrow L), such that the effective cutting line 11 can completely cover the harvest surface of the growing bed 3. The invention further shows a first dispensing device 12 for applying to the harvest surface 3A an insulation layer 13 for insulating fungi and pathogens, in this case formed by a film; and a second dispensing device 14, for applying to the insulation layer 13 a carrier layer 15 for harvested mushrooms 2, in this case formed by a cloth.

The first and second dispensing devices 12, 14 are linked in position to the effective cutting line 11 of the knifes 5-10 and, together with the assembly of knifes 4 relative to the bed 3, are movable for applying the insulating layer 12, 14 and/or the carrier layer at a fixed distance from the effective cutting line 11 of the knife and thus on a harvested part of the harvest surface 3.

The first and/or second dispensing device include a dispensing point formed by a shaft 16, which is adjacent to the effective cutting line 11 of the assembly of knifes 4, for applying the insulating layer 13 and/or the carrier layer 15 during operation immediately after harvesting. The first and second dispensing devices 12, 14 comprise a roller on which the insulating layer 13 and the carrier layer 15 are applied, the rollers being arranged in the width direction B adjacent to the harvest surface 3A and both guided around a bending line 16 that extends with both a directional component in the longitudinal direction L and in the transverse direction B, and therefore diagonally across the harvesting surface 3A, for applying the insulating layer 13 and the carrier layer 15 during use in a longitudinal direction L (actually M) of the growing bed 3. For smooth transfer of the mushrooms from the assembly of knifes 4 to the carrier layer 15, a takeover plane 19 is provided.

FIG. 2 shows the device 1 from FIG. 1 applied to a rack 18 with several cultivation beds 3, positioned side by side and one above the other, on which there is also a discharge device 17, for discharging the carrier layer in a longitudinal direction from the cultivation bed. The harvested mushrooms 2 may thereby, for example, be discharged on a belt 20 for further processing.

Alternatively, they may be removed from the carrier layer 15 before or during removal of the carrier layer 15 from the bed 3. For the latter purpose, a scanning device 21 may be present, for scanning harvested mushrooms 2 on the carrier layer 15 for (optically) determining the weight of the harvested mushrooms 2, and a sorting device for sorting the mushrooms by weight and/or a packaging device for packaging the mushrooms.

The examples shown are for explanation purposes only and do in no way limit the scope of protection as defined in the following claims.

1. A method for harvesting mushrooms from a growing bed, including:
Applying an insulating layer, such as a film, to the growing bed, especially for insulating fungi and pathogens;
Applying a carrier layer, such as a cloth, to the insulation layer to receive harvested mushrooms;
Harvesting mushrooms using a cutting or sawing device and transferring the harvested mushrooms to the carrier layer;
Removing the harvested mushrooms together with the carrier layer from the insulating layer while the insulating layer remains on the growing bed; and
Removing the insulation layer.

2. The method according to claim 1, wherein the applying an insulating layer occurs simultaneously with the applying the carrier layer.

3. The method according to claim 1, wherein the applying the insulating layer, the applying the carrier layer, or both while the using of the cutting and/or sawing device is carried out.

4. The method according to claim 1, comprising mutually moving the growing bed and the cutting or sawing device and a dispensing device for the carrier layer and/or the insulation layer and, optionally also moving the growing bed and the cutting or sawing device and the dispensing device for the carrier layer and/or the insulation layer.

5. The method according to claim 1, wherein the growing bed extends in a longitudinal and a transverse direction, comprising supplying the insulation layer and/or the carrier layer from a side in the transverse direction and discharging to a side in the longitudinal direction at least the carrier layer.

6. A device for harvesting mushrooms from a cultivation bed, the cultivation bed provided with compost, and optionally, casing soil;
wherein the cultivation bed has a harvest surface at an upper end, the harvest surface is adapted so that mushrooms can be cultivated and subsequently harvested thereon; and
wherein the harvest surface extends in a longitudinal and a transverse direction, the harvest surface comprising:
a knife or assembly of knives having an effective cutting edge or effective cutting line, the knife or the assembly of knives extending across a width of the harvest surface with at least one directional component in the broadside direction, wherein the growing bed and the knife or assembly of knives are mutually movable with at least one directional component in the longitudinal direction of the harvest surface, such that an effective cutting plane or an effective cutting line can completely cover the harvest surface;
a first dispensing device for applying an insulating layer, such as a film, to the harvest surface for insulating fungi and germs; and
a second dispensing device, for applying a carrier layer, such as a cloth or net, to the insulation layer for harvested mushrooms.

7. The device according to claim 6, wherein the first dispensing device, and/or the second dispensing device are coupled to the effective cutting plane or the effective cutting line of the knife; and
wherein the first dispensing device, the second dispensing device, or both are movable together with the knife or the assembly of knives relative to the cultivation bed for applying the insulation layer and/or carrier layer at a fixed distance from the effective cutting plane or the effective cutting line of the knife or the assembly of knives, and thereby on a harvested part of the harvest surface.

8. The device according to claim 7, wherein the first dispensing device and/or the second dispensing device comprises a dispensing point adjacent to the effective cutting plane or the effective cutting line of the knife or the assembly of knives, for applying the insulation layer and/or the carrier layer during use immediately after harvesting.

9. The device according to claim 6, wherein the first dispensing device and/or second dispensing device comprises a roller on which the carrier layer is applied, wherein the roller is arranged adjacent to the harvest surface in the width direction and guided around a bending line extending with both a directional component in a longitudinal direction and in a transverse direction, and diagonally across the harvest surface, for applying the carrier layer in a longitudinal direction of the growing bed during use.

10. The device according to claim 6, comprising a discharge device, the discharge device being adapted for longitudinal discharge of the carrier layer from the growing bed; and
wherein the carrier layer is discharged with the harvested mushrooms.

11. The device according to claim 6, wherein the device is provided with:
a scanning device, wherein the scanning device scans for harvested mushroom on the carrier layer and determines the weight of the harvested mushrooms; and/or
a sorting device, wherein the sorting device sorts the harvested mushrooms by weight, shape, or quality; and/or
a packaging device, wherein the packaging device packages the mushrooms.

12. The device according to claim 6, wherein the knife or assembly of knives comprises an assembly of rotating knives or a single saw.

13. The device according to claim 6, wherein the device comprises a takeover plane extending between a cutting or a sawing device and the carrier layer.

14. Shelving, wherein the shelving comprises several beds, the several beds arranged on either side of a central upright and
wherein each bed of the several beds is freely accessible from a side of the each bed facing away from the central upright, comprising at least one device according to claim 6.

15. The shelving according to claim 14, wherein the several beds are placed one above the other.
